(19) United States
(12) Patent Application Publication
(10) Pub. No.: US 2026/0305871 A1
(43) Pub. Date: Oct. 8, 2026

(54) Portable Cooking and Warming Device

(71) Applicants: Consuella Bailey, Palm Beach Gardens, FL (US); Lamont Bailey, Palm Beach Gardens, FL (US)

(72) Inventors: Consuella Bailey, Palm Beach Gardens, FL (US); Lamont Bailey, Palm Beach Gardens, FL (US)

(21) Appl. No.: 19/234,499

(22) Filed: Jun. 11, 2025

Related U.S. Application Data
(60) Provisional application No. 63/785,053, filed on Apr. 8, 2025.

(51) Int. Cl. A47J 36/24; A47J 36/02; A47J 36/14; A47J 43/28; H05B 1/02

(52) U.S. Cl. CPC A47J 36/2483; A47J 36/025; A47J 36/14; A47J 43/281; H05B 1/0269

(57) ABSTRACT

A portable cooking and warming device is provided. The device is designed for heating and serving soup but adaptable for various food types, comprising a body optimized for portability and heat retention. The body includes a modular, detachable handle that can function as a ladle and a spout for pouring. A heating base is attachable to the body and comprises multiple heating elements and user controls, capable of functioning independently as a hot plate, with surfaces made for durability and thermal distribution. The device operates via electrical power, either through a wall outlet or a rechargeable lithium-ion battery with status indicators. A corresponding method of use is also disclosed, detailing steps for assembling, operating, and utilizing the device's features in various environments lacking conventional kitchen appliances.

### CROSS-REFERENCE TO RELATED APPLICATION

The present application claims priority to, and the benefit of, U.S. Provisional Application No. 63/785,053, which was filed on Apr. 8, 2025, and is incorporated herein by reference in its entirety.

### FIELD OF THE INVENTION

The present invention relates generally to the field of food heating devices. More specifically, the present invention relates to a portable device for heating foods and other liquids. Accordingly, the present disclosure makes specific reference thereto. Nonetheless, it is to be appreciated that aspects of the present invention are also equally applicable to other like applications, devices, and methods of manufacture.

### BACKGROUND

Individuals who frequently consume soup and other heat-sensitive food items often encounter challenges in preparing or reheating meals, particularly in environments where conventional kitchen appliances, such as microwaves, are unavailable. Microwaves can create operational issues when heating soup due to the risk of splattering, especially when containers lack appropriate covers. The resulting mess can lead to additional cleaning and inconvenience. Furthermore, transferring hot soup from traditional pots or bowls can be cumbersome, increasing the risk of spills and burns. In settings such as hotel rooms, offices, dormitories, or travel accommodations, users may lack access to stoves or safe heating elements. These limitations hinder the ability to enjoy warm, homemade-style meals in a consistent and controlled manner. Additionally, reheating solid items like sandwiches or other compact meals becomes impractical without a dedicated heating surface. Individuals may consequently resort to eating cold food or relying on takeout, which can be costly and nutritionally inadequate. A reliable, portable method of heating and serving both liquids and solids is therefore essential for improving convenience and user independence in non-kitchen environments.

Therefore, there exists a long-felt need in the art for a portable cooking and warming device that enables users to heat liquid-based meals such as soup in a safe and efficient manner without the use of a microwave. There also exists a long-felt need in the art for a portable cooking and warming device that allows for mess-free pouring and serving of heated contents through an integrated spout and detachable ladle configuration. Moreover, there exists a long-felt need in the art for a portable cooking and warming device that provides a compact, travel-friendly heating base capable of warming both liquid and solid food items using a standard wall plug or rechargeable battery.

The subject matter disclosed and claimed herein, in one embodiment thereof, comprises a portable cooking and warming device. The device is designed for heating and serving soup but is adaptable for various food types, comprising a body optimized for portability and heat retention. The body includes a modular, detachable handle that can function as a ladle and a spout for pouring. A heating base is attachable to the body and comprises multiple heating elements and user controls, capable of functioning independently as a hot plate, with surfaces made for durability and thermal distribution. The device operates via electrical power, either through a wall outlet or a rechargeable lithium-ion battery with status indicators. A corresponding method of use is also disclosed, detailing steps for assembling, operating, and utilizing the device's features in various environments lacking conventional kitchen appliances.

In this manner, the portable cooking and warming device of the present invention accomplishes all the foregoing objectives and provides a device that enables users to heat and serve meals efficiently in environments lacking conventional kitchen appliances. Further, the detachable handle that doubles as a ladle and facilitates safe stirring and serving, while an oversized spout with integrated pour control features minimizes spills during the transfer of liquids. The attachable heating base further includes adjustable temperature settings, allowing for controlled heating of both the kettle and separate cookware when used as a standalone hot plate. Power options via wall plug or rechargeable battery expand the usability to mobile and remote settings. By combining these elements into a compact and versatile system, the portable cooking and warming device enables convenient preparation and reheating of both liquids and solids, addressing key limitations found in existing solutions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable cooking and warming device. The portable cooking and warming device is a multifunctional apparatus designed for heating and serving soup and other foods in both stationary and mobile environments. The device is comprised of a kettle-shaped body configured for portability and thermal efficiency, enabling use in locations lacking conventional kitchen appliances.

In one embodiment, the body includes a removable inner liner comprised of heat-retaining, food-safe materials such as ceramic composites or borosilicate glass. The liner is secured within the body using fasteners and may include a non-stick coating to enhance usability. At least one volumetric measurement indicator is included within the inner liner or the body interior. These indicators provide accurate portioning using high-visibility markings or thermochromic guides.

The device is also comprised of a modular, detachable handle, is included and may be used as a ladle or stirring utensil. The handle features a contoured scoop end and is attached to the body via fasteners such as twist-locks or magnetic docks. The device is further comprised of a spout assembly for controlled pouring. The spout may include at least one pour control such as hinged covers or flow restrictors for adjusting flow rate.

The device is also comprised of an attachable heating base comprising at least one heating element such as resistive coils or induction plates. The base features multiple heating levels, a temperature display, and user controls for adjusting operation. The base may also function independently as a hot plate, supporting additional cookware.

The heating base may include non-slip feet and a thermally shielded bottom surface to prevent damage to support surfaces during operation. Materials such as silicone and aerogel laminates are used for safety and stability.

The device may be powered via a wall outlet or a rechargeable lithium-ion battery integrated within the base. The battery supports full cooking cycles and is rechargeable through various port types. At least one indicator light shows the battery status.

A method of using the device is also disclosed. The device is assembled with its components, including the body, liner, handle, spout, and heating base. Food is placed within the liner using the measurement indicators. The base may be attached or used separately. The user selects a temperature setting via controls, and the heating status is monitored via a display. Food may be stirred or ladled using the detachable handle configured as a scoop.

Accordingly, the portable cooking and warming device of the present invention is particularly advantageous as it provides a device that enables users to heat and serve meals efficiently in environments lacking conventional kitchen appliances. Further, the detachable handle that doubles as a ladle and facilitates safe stirring and serving, while an oversized spout with integrated pour control features minimizes spills during the transfer of liquids. The attachable heating base further includes adjustable temperature settings, allowing for controlled heating of both the kettle and separate cookware when used as a standalone hot plate. Power options via wall plug or rechargeable battery expand the usability to mobile and remote settings. By combining these elements into a compact and versatile system, the portable cooking and warming device enables convenient preparation and reheating of both liquids and solids, addressing key limitations found in existing solutions.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable cooking and warming device of the present invention in accordance with the disclosed architecture;

FIG. 2 illustrates a perspective view of one potential embodiment of a portable cooking and warming device of the present invention with the handle detached from the body and also showing the liner in accordance with the disclosed architecture;

FIG. 3 illustrates a perspective view of one potential embodiment of a portable cooking and warming device of the present invention with the base detached from the body in accordance with the disclosed architecture; and

FIG. 4 illustrates a flowchart of a method of using one potential embodiment of a portable cooking and warming device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a portable cooking and warming device that enables users to heat liquid-based meals such as soup in a safe and efficient manner without the use of a microwave. There also exists a long-felt need in the art for a portable cooking and warming device that allows for mess-free pouring and serving of heated contents through an integrated spout and detachable ladle configuration. Moreover, there exists a long-felt need in the art for a portable cooking and warming device that provides a compact, travel-friendly heating base capable of warming both liquid and solid food items using a standard wall plug or rechargeable battery.

The present invention, in one exemplary embodiment, is comprised of a portable cooking and warming device. The portable cooking and warming device is a multifunctional apparatus configured for heating and serving soup and other food items in both stationary and mobile settings. The device is comprised of a kettle-shaped body designed for portability and thermal efficiency, allowing operation in environments without traditional kitchen appliances.

In one embodiment, the body includes a removable inner liner comprised of heat-retaining, food-safe materials such as ceramic composites or borosilicate glass. The liner is secured within the body using fasteners and may feature a non-stick coating to improve functionality. At least one volumetric measurement indicator is positioned on the inner liner or the interior surface of the body, using high-visibility markings or thermochromic guides for accurate portioning.

The device is also comprised of a modular, detachable handle that may be used as a ladle or stirring tool. The handle features a contoured scoop end and is affixed to the body using fasteners such as twist-locks or magnetic docks. A spout assembly is further included for controlled pouring, with at least one pour control element, such as a hinged cover or flow restrictor to adjust the flow rate.

An attachable heating base is also included, comprising at least one heating element such as resistive coils or induction plates. The base supports multiple heating levels, features a temperature display, and includes user controls for operation adjustment. The base may function independently as a hot plate, supporting other compatible cookware.

The heating base may also include non-slip feet and a thermally shielded bottom surface to protect supporting surfaces during use. Safety and stability are supported by materials such as silicone and aerogel laminates.

Power may be supplied through a wall outlet or a rechargeable lithium-ion battery integrated within the base. The battery supports complete cooking cycles and is rechargeable via multiple port types. At least one indicator light displays the battery charge status.

A method of use is also disclosed. The device is assembled with its components, including the body, liner, handle, spout, and heating base. Food is placed inside the liner using the volumetric indicators. The base may be attached to the body or used separately. A heating mode and temperature are selected using the controls, and the heating process is monitored via the display. Stirring or serving may be performed using the detachable handle configured as a scoop.

As a result, the portable cooking and warming device provides an effective solution for heating and serving meals in settings without conventional kitchen infrastructure. The detachable handle, which also functions as a ladle, enables safe stirring and serving, while the oversized spout with integrated pour control minimizes spills during liquid transfer. The attachable heating base includes adjustable temperature settings and may be used independently, increasing versatility. Power options via wall plug or rechargeable battery enhance mobility. By integrating these features into a compact system, the device supports convenient preparation and reheating of both solids and liquids, addressing key limitations of existing products.

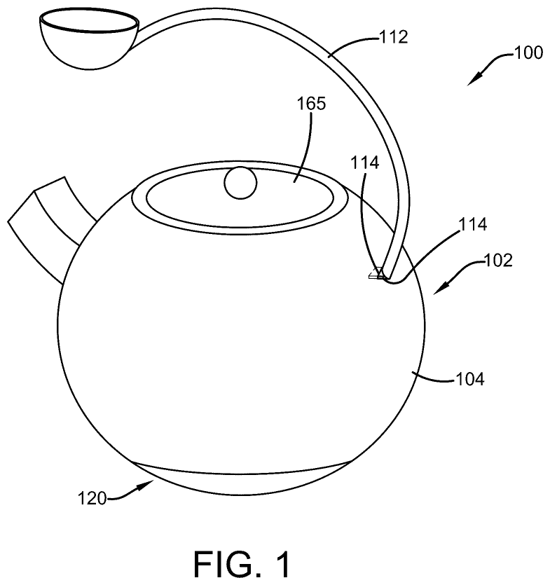

Referring initially to the drawings, FIG. 1 illustrates a perspective view of one potential embodiment of a portable cooking and warming device 100 of the present invention in accordance with the disclosed architecture. The portable cooking and warming device 100 is a multifunctional cooking and warming apparatus primarily intended for heating and serving soup but also adaptable for other food types. The device 100 is comprised of a portable, kettle-shaped cooking system with features that enable heating, reheating, and serving of liquids and solids in both stationary and mobile environments, including, but not limited to, homes, hotels, recreational vehicles, and remote settings without conventional kitchen appliances.

The device 100 is comprised of a body 102 that resembles a traditional upright kettle. However, the body 102 may be constructed in various shapes, including cylindrical, bulbous, or semi-conical configurations, and may be manufactured in different capacities suitable for personal or group meal preparation. The form factor is optimized for portability and efficient heat retention.

The body 102 may be comprised of an outer shell 104 formed from double-walled, vacuum-sealed stainless steel or alternative thermally insulative materials such as anodized aluminum, reinforced polymers, titanium alloys, etc. This construction supports thermal efficiency, minimizes external heat transfer, and provides a cool-touch surface for user safety. The body 102 may be comprised of a lid 165 of any lid style known in the art.

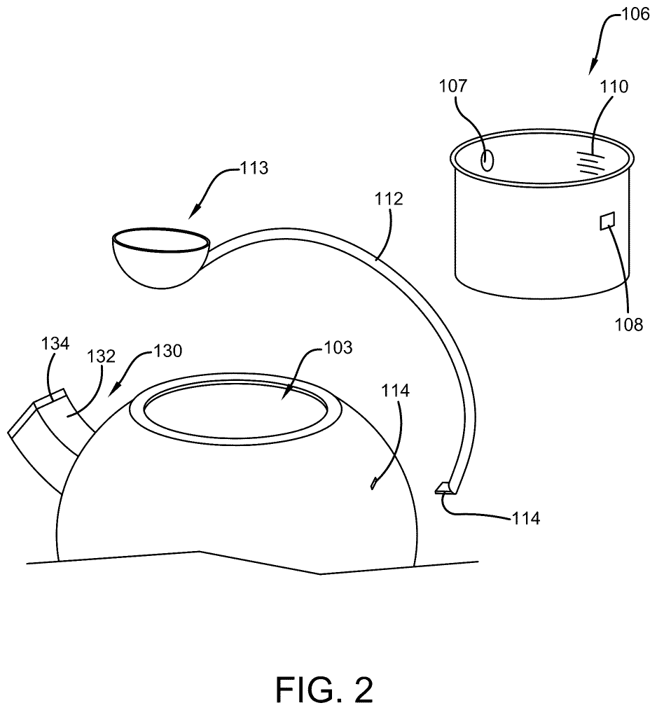

The interior of the body 102 may be comprised of a removable inner liner 106 in one embodiment, as seen in FIG. 2. The liner 106 may be constructed from ceramic composites, borosilicate glass, enameled steel, or other food-safe, heat-retaining materials. This liner 106 is dimensioned to fit securely within the body 102 and may include a non-stick coating 107 for improved performance. The liner 106 is removably secured to the body 102 via at least one fastener 108, such as, but not limited to, a magnetic seating mechanism, bayonet locking ring, compression-fit gasket, keyed alignment tabs, etc.

The inner liner 106 and/or the inner surface 103 of the body 102 may be comprised of at least one volumetric measurement indicator 110. The indicators 110 may include laser-etched or contrast-marked lines, high-visibility fill guides, thermochromic level markers, etc., providing accurate measurement references for food preparation.

The body 102 is further comprised of a handle 112, which in one embodiment is modular and detachable, as seen in FIG. 2. The handle 112 may be shaped like a traditional kettle grip but may be removed and used as a ladle or stirring utensil. The dual-purpose handle 112 is connected to the body 102 via reciprocating fasteners 114, which may be twist-locks, magnetic docks, snap-fit latches, etc. In a ladle embodiment, the handle 112 is comprised of a contoured scoop end 113.

The device 100 is also comprised of a spout assembly 130. The spout 132 in this embodiment is oversized to enable an easier and cleaner pour. The spout 132 may be integrally formed with the body 102. The spout 132 is comprised of at least one pour control 134 in one embodiment, which may include hinged covers, sliding flow restrictors, rotating selector disks, etc. These pour controls 134 enable precise regulation of flow rate, from a narrow stream to a full-volume pour, minimizing spills and user effort.

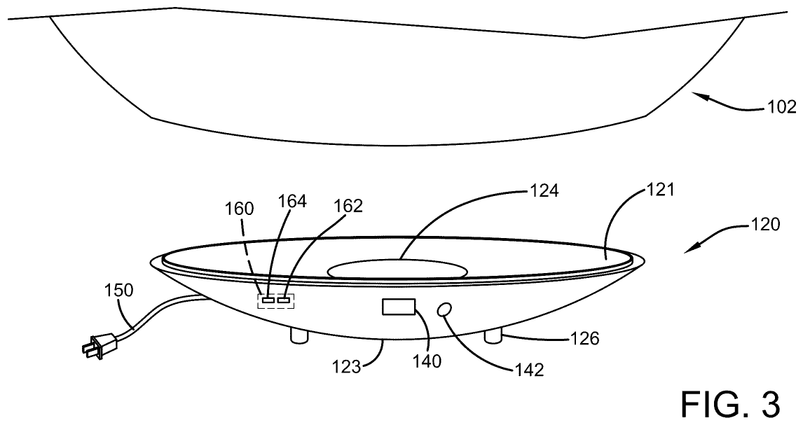

The device 100 is also comprised of a base 120 that serves as an attachable heating platform configured to thermally couple with the body 102. In one embodiment, the base 120 is comprised of at least one heating element 124 that may include resistive coils, induction plates, and/or radiant ceramic disks embedded within the top surface 121, as seen in FIG. 3. The base 120 is further comprised of at least one heating element 124. The heating element 124 supports a plurality of heating levels. The temperature of the heating element 124 may be displayed via at least one display 140, such as an LED panel, digital LCD, or segmented icon interface. Selection of temperature and mode may be configured using at least one control 142 such as, but not limited to, rotary knobs, capacitive sensors, or tactile push buttons.

The heating base 120 is not limited to use with the kettle body 102. In an alternative configuration, the heating base 120 may function independently as a portable hot plate, allowing users to heat other food items such as frying pans, sauce containers, or small pots. The top surface 121 of the base 120 may be fully or partially flat or concave and may be made from a tempered borosilicate glass, glazed ceramic, or composite stone for improved durability, heat distribution, and cleanability.

The base 120 may include at least one non-slip foot 126 and/or bottom surface 123 constructed from high-friction materials such as silicone or thermoplastic elastomer. This configuration enhances safety and stabilizes the device on various surfaces. In one embodiment, the bottom surface 123 of the heating base 120 is thermally shielded using materials such as aerogel laminates, reflective aluminum, or vented insulators, which prevent heat from damaging underlying surfaces during operation.

The portable cooking and warming device may be powered by at least one electrical source. In one configuration, the device is powered by a wall outlet via a detachable or retractable power cord 150. In another embodiment, the device is powered by a rechargeable lithium-ion battery 160 located within the base 120. The battery 160 supports full cooking cycles and may be recharged through a charging port 162, such as a USB-C port, magnetic dock, or barrel plug. The battery 160 is further comprised of at least one indicator light 164, which may be a segmented LED bar, numeric display, or multicolor signal ring that shows the remaining battery life and charging status.

As a result of these combined configurations, the portable cooking and warming device 100 provides users with a compact, self-contained system capable of preparing or warming soup and a wide range of other meals. Its oversized spout, multifunctional ladle-handle, and independent hot plate functionality offer both convenience and flexibility, supporting meal preparation in locations where full kitchen access is limited or unavailable.

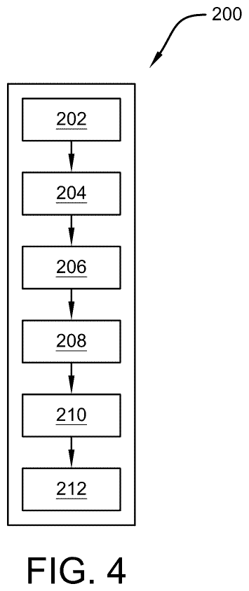

The present invention is also comprised of a method of using 200 the device 100, as seen in FIG. 4. First, a device 100 is provided comprised of a body 102 comprised of an outer shell 104, a removable inner liner 106 with at least one volumetric measurement indicator 110, a detachable handle 112, a spout assembly 130 with at least one pour control 134, and a base 120 comprised of at least one heating element 124 and at least one control 142 [Step 202]. In an embodiment with an inner liner 106, the liner 106 can be inserted into the body 102, and food or liquid can be placed within the inner liner 106 using the volumetric measurement indicators 110 for portion guidance [Step 204]. Next, the base 120 can be attached to the body 102 such that the heating element 124 is thermally coupled to the body 102, or the base 120 can remain unattached depending upon the desired use [Step 206]. Then, the desired heating mode and temperature level can be selected using the control 142, and the corresponding heating status can be confirmed via the display 140 [Step 208]. If the base 120 is being used with the body 102, a piece of cookware containing a food item and/or a solid/liquid can be placed on a top surface 121 of the base 120 [Step 210]. Next, the user may stir or ladle the food within the body 102 using the detachable handle 112 configured as a ladle with scoop end 113 if desired [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable cooking and warming device” and “device” are interchangeable and refer to the portable cooking and warming device 100 of the present invention.

Notwithstanding the foregoing, the portable cooking and warming device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable cooking and warming device 100 as shown in the FIGS. are for illustrative purposes only, and that many other sizes and shapes of the portable cooking and warming device 100 are well within the scope of the present disclosure. Although the dimensions of the portable cooking and warming device 100 are important design parameters for user convenience, the portable cooking and warming device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable cooking and warming device comprising:
a body comprising a spout and a detachable handle removably attached to the body, the handle being configured for use as a ladle; and
a base configured to thermally couple with a body, the base comprising a heating element and a battery that supplies power to the heating element.

2. The portable cooking and warming device of claim 1, wherein the heating element is comprised of a resistive coil, an induction plate, or a radiant ceramic disk.

3. The portable cooking and warming device of claim 1, wherein the battery is comprised of a rechargeable battery.

4. The portable cooking and warming device of claim 3, wherein the battery is comprised of a charging port.

5. The portable cooking and warming device of claim 1, wherein the detachable handle removably attaches to the body via a pair of reciprocating fasteners.

6. The portable cooking and warming device of claim 1, wherein the handle is comprised of a contoured scoop end.

7. The portable cooking and warming device of claim 1, wherein a top surface of the base is concave.

8. The portable cooking and warming device of claim 1, wherein an outer shell of the body is formed from a thermally insulative material.

9. A portable cooking and warming device comprising:
a body comprising a spout comprised of a pour control, and a detachable handle connected to the body, the handle being configured for removal and use as a ladle;
a removable liner disposed in the body;
a base configured to thermally couple with a body, the base comprising a heating element, a control, and a battery that supplies power to the heating element.

10. The portable cooking and warming device of claim 9, wherein the removable liner is comprised of a non-stick coating.

11. The portable cooking and warming device of claim 9, wherein the battery is comprised of a rechargeable battery.

12. The portable cooking and warming device of claim 11, wherein the battery is comprised of a charging port.

13. The portable cooking and warming device of claim 9, wherein the detachable handle removably attaches to the body via a pair of reciprocating fasteners.

14. The portable cooking and warming device of claim 9, wherein the handle is comprised of a contoured scoop end.

15. The portable cooking and warming device of claim 9 further comprised of a power cord.

16. The portable cooking and warming device of claim 9, wherein the base is comprised of a non-slip foot.

17. The portable cooking and warming device of claim 9, wherein the base is comprised of a thermally shielded bottom surface.

18. The portable cooking and warming device of claim 9 further comprised of an indicator light.

19. The portable cooking and warming device of claim 9 further comprised of a display.

20. A method of using a portable cooking and warming device, the method comprising the following steps:
providing a portable cooking and warming device comprised of a body comprised of a spout assembly, a detachable handle attached to the body, and a base comprising a heating element and a control;
attaching the base to the body such that the heating element is thermally coupled to the body;
selecting a desired heating mode and temperature level of the heating element using the control to heat a food or a liquid within the body; and
stirring or ladling the food from within the body using the detachable handle.
